(19) United States
(12) Patent Application Publication
(10) Pub. No.: US 2009/0284513 A1
(43) Pub. Date: Nov. 19, 2009

(54) LIQUID CRYSTAL DISPLAY CONTROL SYSTEM AND METHOD

(76) Inventors: Paul Fredrick Weindorf, Novi, MI (US); James Cameron Aldrich, Owosso, MI (US)

Correspondence Address: VISTEON/BRINKS HOFER GILSON & LIONE, 524 South Main Street, Suite 200, Ann Arbor, MI, 48104, US

(21) Appl. No.: 12/123,060

(22) Filed: May 19, 2008

(51) Int. Cl. G09G 5/00; G09G 3/36

(52) U.S. Cl. 345/211; 345/87

(57) ABSTRACT

A system and method for adjusting a supply voltage provided by a power supply to a liquid crystal display includes a liquid crystal display having a glass panel, a power supply electrically connected to the liquid crystal display, the power supply configured to provide a supply voltage to the liquid crystal display, a temperature sensor configured to measure the temperature of the glass panel of the liquid crystal display and output a temperature output indicative of the temperature of the glass panel of the liquid crystal display, and a processor in communication with the power supply and the temperature sensor.

### BACKGROUND OF THE INVENTION

1. Field of the Invention

This invention relates to control systems for liquid crystal displays (“LCDs”).

2. Description of the Known Art

Passively driven Super Twisted Neumatic (“STN”) LCDs have competitive advantages over competing technologies such as Vacuum Fluorescent Displays (“VFDs”), Passive Organic Light Emitting Diode Displays (“OLEDs”) and a host of passively addressed Electrophoretic Electronic Paper type displays. STN LCDs generally are capable of operating at much higher multiplex ratios than VFDs and Passive OLEDs resulting in higher resolution capability. LCDs do not suffer from pixel aging image burn-in as experienced by emissive VFDs and OLEDs when the same image is displayed for long periods of times. Unlike most Electrophoeretic Displays, LCDs can be backlit which is an important attribute for night time operation such as in vehicular applications.

However, STN LCDs require that the supply voltage of the STN LCD be adjusted relatively carefully. If the supply voltage is not carefully adjusted, the STN LCD may be difficult for a user to perceive. Unfortunately, setting the supply voltage once will not be suitable because the supply voltage required for a user to perceive the STN LCD changes as a function of temperature. Referring to FIG. 1, a graph generally representing the appropriate supply voltage (VLCD), as it relates to temperature, is shown. Generally, as the temperature increases, the supply voltage is generally decreased.

STN LCDs used in environments where the temperature remains relatively stable, such as STN LCDs found in a home environment, generally do not need a sophisticated feedback system to adjust the supply voltage as the temperature changes. However, in environments where the there is a broad temperature range, such as the occupant compartment of an automobile, the STN LCD requires a sophisticated feedback system to properly adjust the supply voltage based upon a measured temperature reading.

Prior art systems generally incorporate a temperature monitor located on or near the glass panel of the LCD, so as to measure the temperature of the glass panel of the LCD. The temperature monitor outputs a signal indicative of the temperature of the glass panel to a microprocessor. The microprocessor then sends an adjustment signal to a power supply that later adjusts the supply voltage accordingly. However, it has been discovered that this type of system does not always accurately adjust the supply voltage. Additionally, these systems may adjust the supply voltage in a linear fashion which, as shown in FIG. 1, is not suitable because the relationship between the supply voltage as it relates to temperature is not linear. Therefore, there is a need for an improved LCD control system and method.

### BRIEF SUMMARY OF THE INVENTION

A system for adjusting a supply voltage provided by a power supply to an LCD, according to the principles of the present invention includes an LCD having a glass panel, a power supply electrically connected to the LCD, the power supply configured to provide a supply voltage to the LCD, a temperature sensor configured to measure the temperature of the glass panel of the LCD and output a temperature output indicative of the temperature of the glass panel of the LCD, and a processor in communication with the power supply, the temperature sensor and a precise voltage reference.

In its simplest form, the processor is configured to determine a desired voltage based on the temperature of the glass panel of the liquid crystal display. From there, the processor determines an error between the desired voltage and the supply voltage. Finally, the processor adjusts the supply voltage based on the error to output the desired voltage.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a chart showing the relationship between the temperature of a glass panel of an LCD and an optimal supply voltage

FIG. 2 is a perspective view of an LCD embodying the principles of the present invention;

FIG. 3 is a block diagram of the LCD of FIG. 2 and an LCD control system embodying the principles of the present invention;

FIG. 4 is a flow chart illustrating a method for adjusting a supply voltage provided by a power supply to the LCD of FIG. 2;

FIG. 5 is a flow chart illustrating a method for determining a desired voltage for the LCD of FIG. 2;

FIG. 6 is a flow chart illustrating a method for determining an error between the desired voltage and the supply voltage for the LCD of FIG. 2;

FIG. 7 is a flow chart illustrating a method for adjusting the supply voltage based on the error to output the desired voltage; and

FIG. 8 is a flow chart illustrating the methods of FIGS. 5-7.

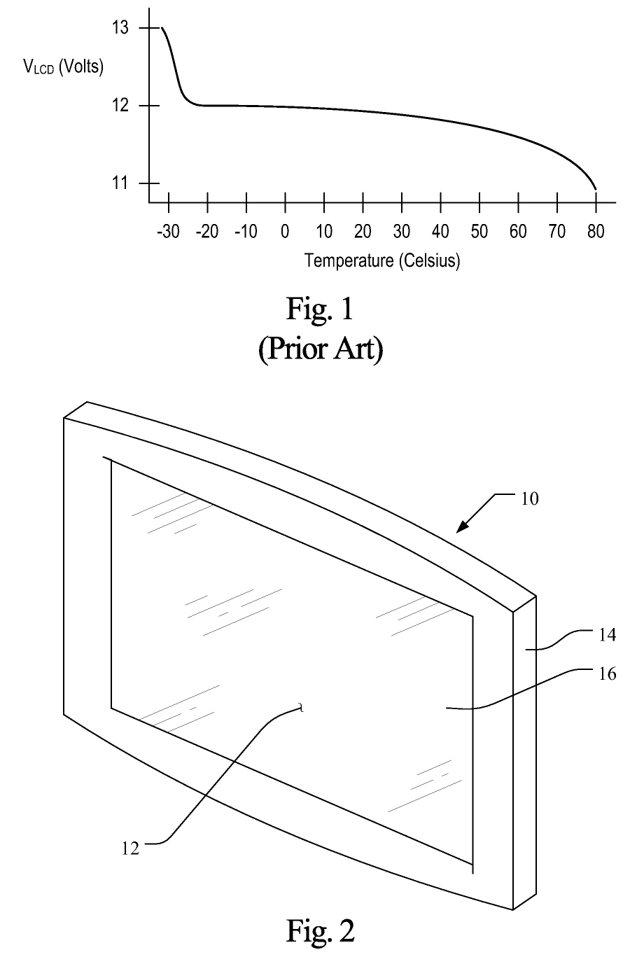

### DETAILED DESCRIPTION OF THE INVENTION

Referring to FIG. 2, an LCD 10 is shown. The LCD 10 generally includes a display area 12 whose periphery may be surrounded by a housing 14. Of course, it should be understood that the display area 12 may incorporate into an instrument cluster of an automobile. The housing 14 functions to protect the LCD 10 from environmental hazards. A transparent panel 16, generally made of glass or plastic, is retained by the housing 14 over the display area 12. Similar to the housing 14, the panel 16 protects the LCD 10 from environmental hazards as well as providing a transparent area for which the display area 12 can be perceived by a user.

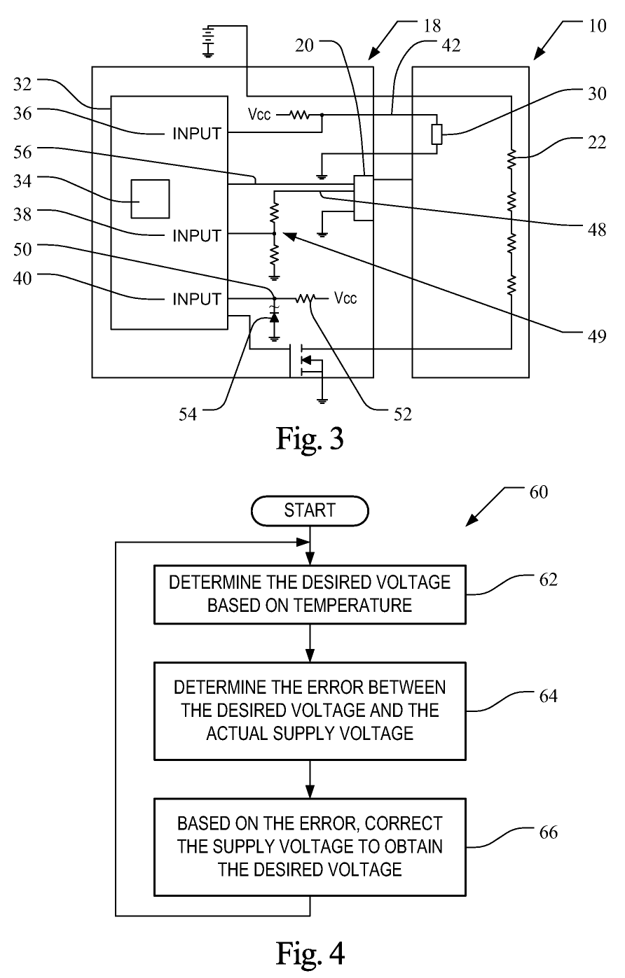

Referring to FIG. 3, a block diagram of the LCD 10 and a control system 18 is shown. The LCD 10 may include a heating element 22 for heating the LCD 10. The heating element 22 is generally a material such as indium tin oxide (“ITO”) applied to the one of the glass layers of the LCD 10 of FIG. 3. Electrical current is then passed through the ITO coating to generate heat, so as to improve the response time of the LCD 10 at low temperatures. The LCD 10 also includes a temperature monitor 30 for measuring and outputting the temperature of the glass panel 16 of FIG. 2.

The control system 18 includes a processor 32 configured by a set of instructions 34. The control system 18 also includes a power supply 20 that provides a supply voltage to the LCD 10. The processor 32 includes an analog to digital converter (“A/D”) with inputs. The inputs 36, 38, and 40 are multiplexed to the A/D of the processor 32. The input 36 is in communication with a temperature output 42 of the temperature monitor 30. When the input 36 receives the temperature output 42 of the temperature monitor 30, the input 36 will convert the temperature output 42 from an analog signal to a digital signal so that the processor 32 can interpret the data received from the temperature output 42.

The input 38 is in communication with a power supply output 48 via a voltage divider 49. The input 38 converts the output 48 of the power supply 20 to a digital signal so that the processor 32 can properly interpret the output 48 of the power supply 20.

The input 40 is connected to a voltage point 50. The voltage point 50 is located between a resistor 52 and a precision instrument 54. The voltage point 50 represents a known predetermined voltage value. As will be described with more detail later in this description, the input 40 will measure the voltage point 50 so as to determine if the voltage point 50 is at the correct predetermined amount. If the voltage point 50 is not at the correct predetermined amount, the microprocessor 32 will correct the error of the supply feedback 38.

Finally, the processor 32 is connected to an input 56 of the power supply 20. The input 56 of the power supply 20 allows the microprocessor 32 to control the power supply 20 based on the error value. This error value is essentially added the current control value. When the power supply 20 receives a new control value from the processor 32, the power supply 20 will adjust the supply voltage to the LCD 10 to compensate for this error value.

Referring to FIG. 4, a method 60 for adjusting the supply voltage of the LCD 10 is shown in its simplest form. As shown in step 62, the processor 32 first determines a desired voltage based on the temperature of the glass panel 16. Thereafter, as shown in step 64, the processor 32 determines the error between the desired voltage and the actual supply voltage of the power supply 20. Thereafter, the processor 32 adjusts the supply voltage outputted by the power supply 20 based on the error calculated in step 64.

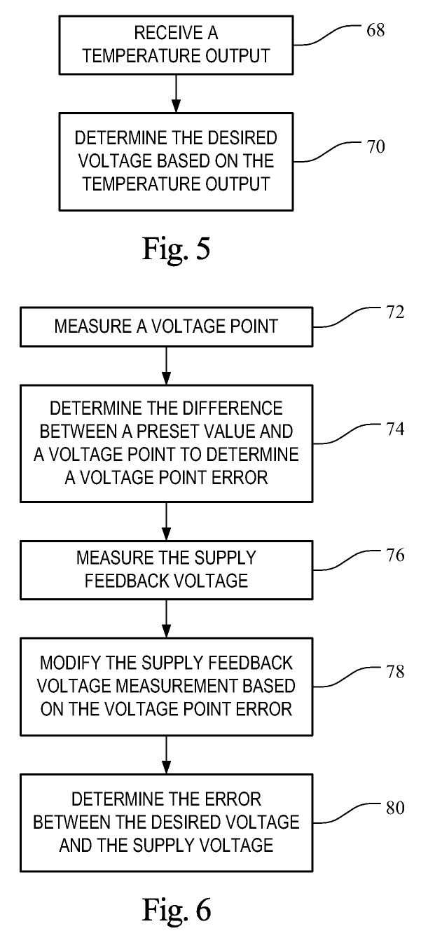

As stated previously, FIG. 4 illustrates the method 60 in its most simplest form. FIGS. 5-7 illustrate the steps of method 60 of FIG. 4 in more detail. As such, referring to FIG. 5, step 62 of method 60 is explained in more detail. First, as shown in step 68, the processor 32 at input 36 receives a temperature output 42 from the temperature sensor 30. Next, as illustrated in step 70, the processor 32 determines the desired voltage based on the temperature output received in step 68.

Referring to FIG. 6, the more detailed explanation of step 64 of FIG. 4 is shown. As a reminder, step 64 stated that the processor 32 determines the error between the desired voltage and the actual supply voltage. First, as illustrated in step 72, the processor 32 at input 40 measures the voltage point 50. Next, at step 74, the processor 32 then determines the difference between a preset value and the voltage point 50 to determine a voltage point error. Generally, the preset value and the voltage point 50 should be the same value. Thereafter, a processor 32 at input 38 measures the feedback value 49.

It has been discovered that the power supply 20 does not always output a supply voltage that matches previously determined desired voltage due to A/D converter errors. In an effort to make up for this deficiency, the feedback value 49 is corrected as a result of the error measured at the voltage point 50. In step 78, the supply feedback voltage 49 is modified based on the voltage point error. Thereafter, in step 80, the error between the desired voltage and the supply feedback voltage is corrected for A/D converter errors by using the voltage point error.

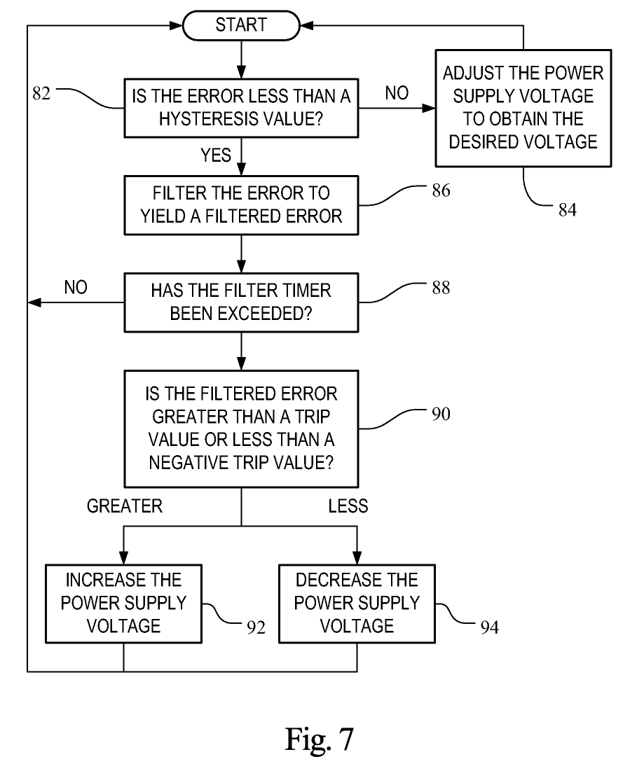

FIG. 7 explains in more detail step 66 of method 60. As a reminder, step 66 was the step of adjusting the supply voltage to obtain the desired voltage based on the calculated error between the voltage point corrected supply voltage feedback and the desired value. In step 82, a determination is made by the processor 32 if the error is less than a preset hysteresis value.

As shown in step 84, if the error is not less than a hysteresis value, the processor 32 adjusts the power supply voltage to obtain the desired voltage by adding (or subtracting depending on the loop polarity configuration) a proportion of the error to the current power supply control value. This allows the feedback loop to quickly get to within the hysteresis value (conventional PID control loop). However, if the error is less than the hysteresis value, the error is filtered as shown in step 86.

While the error is being filtered, a determination is made, as shown in step 88, if the filter timer has been exceeded. If the filter timer has not been exceeded, the method returns to step 82. Otherwise, the method continues to step 90 where a determination is made if the filtered error is greater than a trip value or less than a negative trip value. If the filtered error is greater than the trip value, the power supply is instructed to increase the voltage to the LCD by a small amount, usually around 20 millivolts as shown in step 92. If the filtered error is less than the negative trip value, the voltage to the LCD from the power supply is decreased by a small amount usually 20 millivolts as shown in step 94. If no condition is true step 90, the method returns all the way to step 68 of FIG. 5.

It is important to recognize is that if the error is greater than the hysteresis value, then the supply voltage is at least 8 counts away from the desired value and PID loop, as disused in step 84, is used to quickly adjust the supply voltage by adding a proportion of the error to the current control value. In this manner, when the supply voltage has a large variation from the desired voltage, it is quickly adjusted to within the hysteresis value via 84. When the error is less than the noise floor (<hysteresis value), then the error is filtered and the loop is controlled in a very slow fashion to get to exactly the desired supply voltage. By so doing, a quick response for large errors and a slow filtered response for errors that are in the noise floor can be achieved.

Noise is a fairly large problem in feedback systems. Here, noise can be present at inputs 36, 38, and 40. By filtering the error, all of the noise sources are filtered to obtain the correct average value (i.e. the average noise is zero and so when you filter the signal you are left with the signal component). This approach avoids filtering each of the input components and allows the loop to respond quickly for large errors such as is seen during power up and during fast temperature changes. The slow nature of the filtered loop does not allow your eye to see any flicker component as a result of only allowing small adjustments to be made periodically.

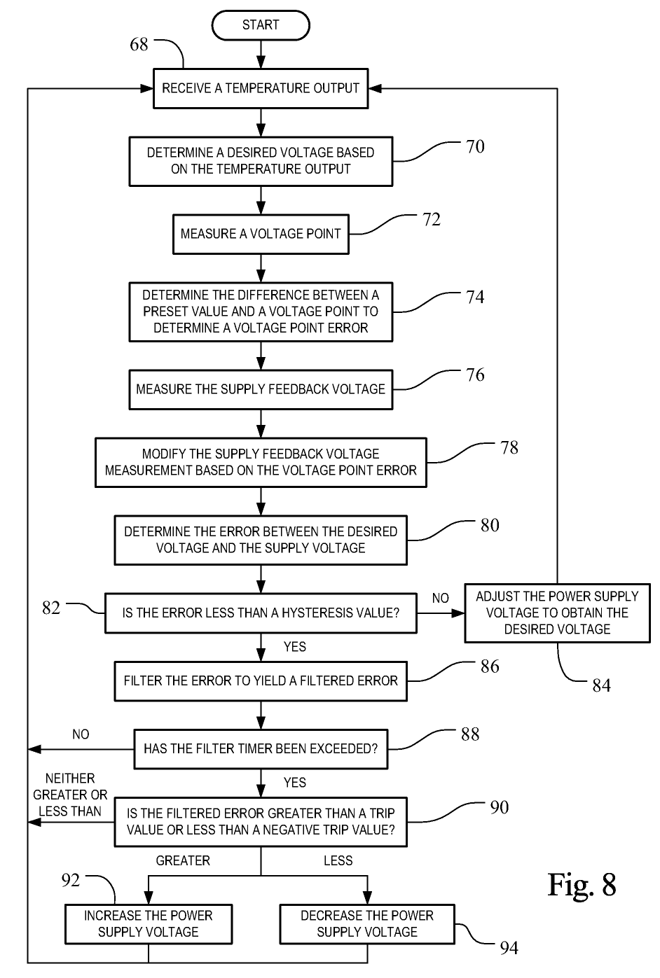

In an effort to better show how the flow chart is shown in FIGS. 5-7 interact, FIG. 8 is provided. In FIG. 8, like reference numerals are used to illustrate like steps shown in FIGS. 5-7.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

1. A method for adjusting a supply voltage provided by a power supply to a liquid crystal display, the method comprising the steps of:
determining a desired voltage for the liquid crystal display based on the temperature of a glass panel of the liquid crystal display;
determining an error between a desired voltage and the supply voltage; and
adjusting the supply voltage based on the error to output the desired voltage.

2. The method of claim 1, wherein the step of determining the desired voltage further comprises the steps of:
receiving a temperature output indicative of the temperature of the glass panel of the liquid crystal display; and
determining the desired voltage based on the temperature output.

3. The method of claim 1, wherein the step of determining the error between the desired voltage and the supply voltage, further comprises the steps of:
measuring a voltage point;
determining a difference between a preset value and the voltage point to determine a voltage point error;
modifying a supply voltage feedback value based on the voltage point error; and
determining the error between the desired voltage and the supply voltage.

4. The method of claim 1, wherein the step of adjusting the supply voltage based on the error to output the desired voltage, further comprises the steps of:
comparing the error to a hysteresis value;
when the error is more than the hysteresis value, adjusting the supply voltage based on the error to obtain the desired the desired voltage by adding or subtracting a proportion of the error to a current power supply control value; and
when the error is less than or equal to the hysteresis value, periodically adjusting the supply voltage to obtain the desired voltage by adding or subtracting an incremental amount to a current supply control value when the error exceeds a predetermined threshold.

5. The method of claim 4, further comprising the step of filtering the error to yield a filtered error.

6. The method of claim 5, further comprising the step of increasing the supply voltage a specific amount when the filtered error is greater than a trip value.

7. The method of claim 5, further comprising the step of decreasing the supply voltage a specific amount when the filtered error is less than a trip value.

8. The method of claim 5, further comprising the step of determining if a filter timer has been exceeded.

9. The method of claim 8, further comprising the step of increasing the supply voltage a specific amount when the filtered error is greater than a trip value and the filter timer has been exceeded.

10. The method of claim 8, further comprising the step of decreasing the supply voltage a specific amount when the filtered error is less than a trip value and the filter timer has been exceeded.

11. A system for adjusting a supply voltage provided by a power supply to a liquid crystal display, the system comprising:
a liquid crystal display having a glass panel;
a power supply electrically connected to the liquid crystal display, the power supply configured to provide a supply voltage to the liquid crystal display;
a temperature sensor configured to measure the temperature of the glass panel of the liquid crystal display and output a temperature output indicative of the temperature of the glass panel of the liquid crystal display; and
a processor in communication with the power supply and the temperature sensor, the processor being configured to:
determine a desired voltage based on the temperature of the glass panel of the liquid crystal display;
determine an error between the desired voltage and the supply voltage; and
adjust the supply voltage based on the error to output the desired voltage.

12. The system of claim 11, wherein the processor is further configured to:
receive the temperature output from the temperature sensor; and
determine the desired voltage based on the temperature output.

13. The system of claim 1, wherein the processor is further configured to:
measure a voltage point;
determine a difference between a preset value and the voltage point to yield a voltage point error;
modify a supply voltage feedback value based on the voltage point error; and
determine the error between the desired voltage and the supply voltage

14. The system of claim 11, wherein the processor is further configured to:
compare the error to a hysteresis value;
when the error is more than the hysteresis value, adjust the supply voltage based on the error to obtain the desired the desired voltage by adding or subtracting a proportion of the error to a current power supply control value; and
when the error is less than the hysteresis value, periodically adjust the supply voltage to obtain the desired voltage by adding or subtracting an incremental amount to a current supply control value when the error exceeds a predetermined threshold.

15. The system of claim 14, further comprising a filter in communication with the processor, the filter configured to filter the error to yield a filtered error.

16. The system of claim 15, wherein the processor is further configured to increase the supply voltage a specific amount when the filtered error is greater than a trip value.

17. The system of claim 15, wherein the processor is further configured to decrease the supply voltage a specific amount when the filtered error is less than a trip value.

18. The system of claim 15, wherein the processor is further configured to determine if a filter timer has been exceeded.

19. The system of claim 18, wherein the processor is further configured to increase the supply voltage a specific amount when the filtered error is greater than a trip value and the filter timer has been exceeded.

20. The system of claim 18, wherein the processor if further configured to decrease the supply voltage a specific amount when the filtered error is less than a trip value and the filter timer has been exceeded.
